(19) United States
(12) Patent Application Publication
(10) Pub. No.: US 2025/0016068 A1
(43) Pub. Date: Jan. 9, 2025

(54) PERFORMANCE GOALS FOR A SYSTEM APPLICATION

(71) Applicant: INTERNATIONAL BUSINESS MACHINES CORPORATION, ARMONK, NY (US)

(72) Inventors: Christopher Neil Bailey, Romsey (GB); Sandra Hayward, Eastleigh (GB); Matthew Paul Wilson, Easteligh (GB); IAN PARTRIDGE, Eastleigh (GB); David Richard Jones, Eastleigh (GB)

(21) Appl. No.: 18/348,615

(22) Filed: Jul. 7, 2023

(51) Int. Cl. H04L 41/5009; H04L 41/5067; H04L 41/5074

(52) U.S. Cl. CPC H04L 41/5009; H04L 41/5067; H04L 41/5074

(57) ABSTRACT

Embodiments of the present invention provide concepts for automatically deriving a performance goal, and such a performance goal may be user or business outcomes (rather than being based on non-specific guidelines). In particular, embodiments may provide a mechanism for deriving a set of performance goals for a system application that ensures sufficient performance to deliver a target user satisfaction (or conversion level).

### BACKGROUND

The technical character of the present invention generally relates to the field of data processing environments and applications, and more particularly, to defining performance goals for system applications.

System applications typically have performance goals, and there are different types of performance goals including Application Performance Index (Appdex) and Service Level Objectives (SLO). By way of example, and performance goal (such as a SLO) may relate to responsiveness that is needed to meet user and/or business requirements.

It is known that there is a relationship between responsiveness of an application and user satisfaction (or conversion rates). Data for these two metrics is readily available. However, it is difficult to define performance goals for an application that optimize operational cost versus user satisfaction. As a result, existing standards use rule-of-thumb thresholds that estimate/predict what a user should expect to find satisfactory.

### SUMMARY

The present invention seeks to provide one or more concepts for defining a performance goal (such as an SLO) for a system application. Such concepts may be computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor. The present invention yet further seeks to provide a system for defining a performance goal for a system application.

According to an aspect of the present invention there is provided a computer-implemented method for defining a performance goal for a system application. The method comprises, for each of a plurality of user interactions with a system application, determining a measure of latency experienced during the user interaction. The method also comprises, for at least of one of the plurality of user interactions with the system application, determining a measure of satisfaction of the user with the interaction. The method then further comprises analyzing the determined measures of latency and satisfaction to determine a target latency value. The method yet further comprises defining a performance goal for the system application based on the target latency value.

Proposed embodiments may thus provide one or more concepts for automatically deriving a performance goal, and such a goal may represent a user or business outcome (rather than being set arbitrarily). In particular, embodiments may provide a mechanism for deriving a set of performance goals for a system application that ensures sufficient performance to deliver a target user satisfaction (e.g., conversion) level.

In addition, embodiments of the present invention provide concepts for a non-transitory computer readable medium comprising code stored thereon that, when executed, performs a method for defining a performance goal for a system application, the method comprising: for each of a plurality of user interactions with a system application, determining a measure of latency of the user interaction (i.e. latency experienced by the user); and for at least of one of the plurality of user interactions with the system application, determining a measure of satisfaction of the user with the interaction; analyzing the determined measures of latency and satisfaction to determine a target latency value; and defining a performance goal for the system application based on the target latency value.

Embodiments may be employed in combination with conventional/existing processing environments and/or applications, such as transaction processing environments for example. In this way, embodiments may integrate into legacy systems to improve and/or extend their functionality and capabilities. An improved processing environment may therefore be provided by proposed embodiments.

According to another aspect, there is provided a system comprising: one or more processors; and a memory comprising code stored thereon that, when executed, performs a method for determining availability of a transaction in a processing environment, the transaction belonging to a class of transactions, the method comprising: for each of a plurality of user interactions with a system application, determining a measure of latency experienced by the user; and for at least of one of the plurality of user interactions with the system application, determining a measure of satisfaction of the user with the interaction; analyzing the determined measures of latency and satisfaction to determine a target latency value; and defining a performance goal for the system application based on the target latency value.

Thus, there may be proposed concepts for defining SLOs for a system application, wherein the concepts provide one or more approaches to correlating latency and user satisfaction to derive a performance goal automatically. These approaches may leverage live data rather than being based on non-specific guidelines, and therefore provide superior (e.g., more accurate) performance goals for achieving desired outcomes.

### BRIEF DESCRIPTION OF THE DRAWINGS

FIG. 1 depicts a computing node according to an embodiment of the present invention;

FIG. 2 depicts an illustrative computing environment according to embodiments of the present invention;

FIG. 3 is a simplified flow diagram of a method according to an embodiment;

FIG. 4 depicts a simplified block diagram of a system according to an embodiment;

FIG. 5 depicts an exemplary graph of Latency versus Satisfaction values which exhibits a linear relationship between satisfaction and latency; and

FIG. 6 depicts an exemplary graph of Latency versus Satisfaction values which exhibits a non-linear relationship between satisfaction and latency.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a portable computing device (such as a tablet computer, laptop, smartphone, etc.), a set-top box, a server, or a collection of PCs and/or servers connected via a network such as a local area network, the Internet and so on to cooperatively execute at least one embodiment of the methods of the present invention.

The technical character of the present invention generally relates the field of processing environments and applications, and more particularly, to defining one or more performance goals for a system application. More specifically, embodiments of the present invention provide concepts for defining a performance goal for a system application based on analysis of measures of latency and satisfaction for user interactions with the system application.

There is provided a method for defining a performance goal for a system application. The method comprises, for each of a plurality of user interactions with a system application, determining a measure of latency experienced by the user. The method also comprises, for at least one of the plurality of user interactions with the system application, determining a measure of satisfaction of the user with the interaction. The determined measures of latency and satisfaction are then analyzed to determine a target latency value. A performance goal for the system application is then determined based on the target latency value.

Accordingly, proposed is a concept for deriving a set of performance goals (e.g., set of SLOs) for a system application (such as a transaction processing application). However, although described in relation to transaction processing environments, embodiments may be applied to other processing environments.

By way of example, the following steps outline a process according to the proposed concept(s):
Step 1: Measure the latency of a user's interactions with the system application;
Step 2: Classify satisfaction of the user (e.g., as satisfied or dissatisfied) using the system application;
Step 3: Analyze the data (e.g., produce a histogram of latency vs. satisfaction for each user interaction), and determine the maximum latency that meets the target satisfaction rate; and
Step 4: Translate the identified latency value into a performance goal for the system application.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

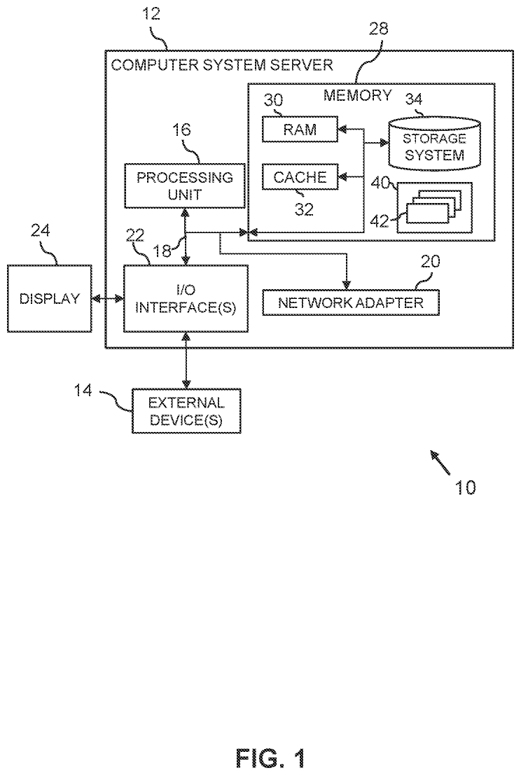

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment.

Program modules 42 generally carry out the functions and/or methodologies of embodiments of the invention as described herein. For example, some or all of the functions of a DHCP client 80 can be implemented as one or more of the program modules 42. Additionally, the DHCP client 80 may be implemented as separate dedicated processors or a single or several processors to provide the functionality described herein. In embodiments, the DHCP client 80 performs one or more of the processes described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID (redundant array of inexpensive disks or redundant array of independent disks) systems, tape drives, and data archival storage systems, etc.

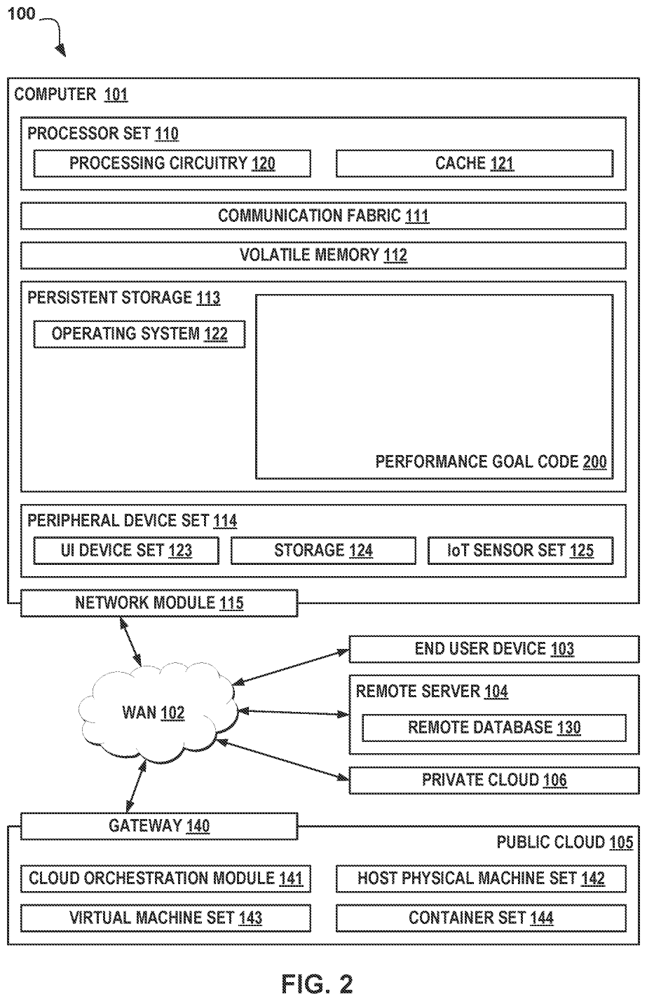

Referring now to FIG. 2, an illustrative computing environment 100 is depicted. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as a proposed method for defining a performance goal for a system application (i.e., performance goal code) 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

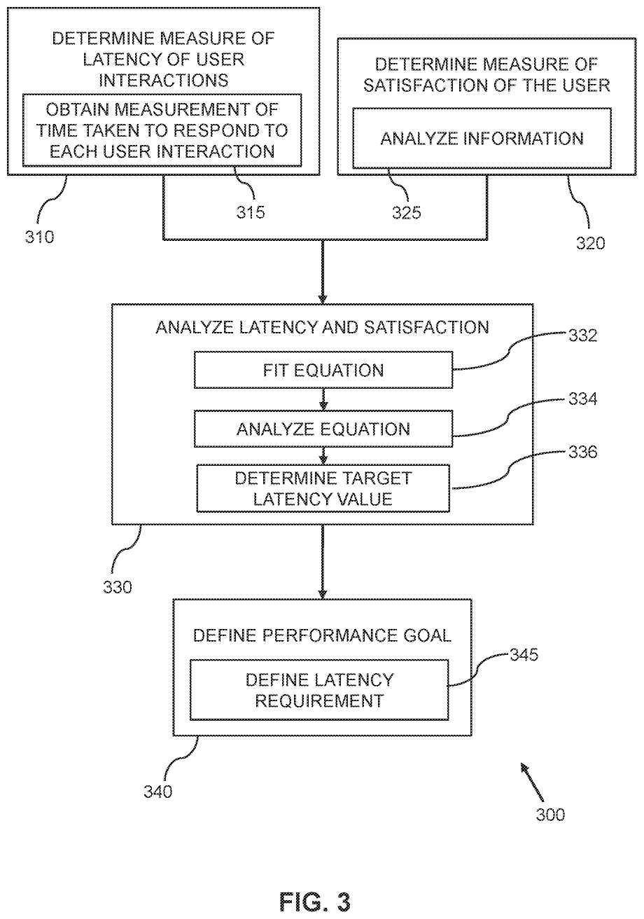

Referring now to FIG. 3, there is depicted a flow diagram of a computer-implemented method 300 for defining a performance goal for a system application according to a purely exemplary embodiment.

The method 300 begins with the steps 310 and 320. Step 310 comprises determining, for each of a plurality of user interactions with a system application, a measure of latency experienced by the user. Here, determining a measure of latency comprises the step 315 of obtaining a measurement of a time taken by the application to respond to a user interaction. For instance, obtaining a measurement of a time taken by the application to respond to a user interaction may comprise measuring, with a monitoring component, the time taken by the application to respond to a user interaction.

Step 320 comprises determining, for at least one of the plurality of user interactions with the system application, a measure of satisfaction of the user with the interaction. Here, determining a measure of satisfaction of the user with the interaction comprises the step 315 of analyzing at least one of: the presence (or not) of a subsequent user interaction with the system application; a user input response to a request for satisfaction information; survey data provided by the user; one or more complaints provided by the user; and a time taken to complete a transaction of the system application.

After completion of steps 310 and 320, the method proceeds to step 330 of analyzing the determined measures of latency and satisfaction to determine a target latency value. In this example, the step 330 of analyzing the determined measures of latency and satisfaction comprises three sub-steps 332, 334 and 336.

In step 332, a mathematical equation is fitted to the determined measures. Then, in step 334, the fitted mathematical equation is analyzed based on a target satisfaction value to identify a latency value for the target satisfaction value. A target latency value is then determined in step 336 based on the identified latency value. Thus, a suitable/appropriate mathematical technique may be applied to fit an equation to the acquired data (i.e., measures of latency and satisfaction), such as an S-Curve Logistics Equation, and the equation can then facilitate determination of a target latency value.

Finally, in step 340, a performance goal is defined for the system application based on the target latency value determined in step 330. Here, step 340 of defining a performance goal comprises the step 345 of defining a requirement for maintaining latency of the system application below the target latency value.

Although step 340 of FIG. 3 has been detailed as defining a requirement for maintaining latency of the system application below the target latency value, the step 340 of defining a performance goal may comprise defining a performance goal for other aspects of the system application. For instance, in an alternative embodiment, a performance goal may be defined for a part of the system application that provides the plurality of user interactions. Also, defining a performance goal for the system application based on the target latency value may comprise defining, based on the target latency, a set of performance goals for the system application.

Similarly, other steps of the method detailed above may be implemented differently in alternative embodiments. For instance, analyzing 330 the determined measures of latency and satisfaction may alternatively comprise generating a graph of user satisfaction versus latency (based on the determined measures of latency and satisfaction), and then analyzing the generated graph to identify a latency value for the target satisfaction value. Such graph analysis may, for example, comprise determining a best fit line for the graph and then employing statistical analysis to identify a latency value at which the best fit line is closest to the target satisfaction value.

From the above description, it will be appreciated that the exemplary method of FIG. 3 may be employed to determine one or more performance goals for a system application. The performance goal(s) may help to ensure a minimum level of user satisfaction is maintained for the application. Also, the method may be repeatedly executed to continually update the performance goal(s) (e.g., periodically or for every user interaction). In this way, embodiments may mirror user satisfaction more realistically based on historic use of the application, and this recalculated regularly to maintain/improve accuracy.

Thus, there are proposed one or more concepts for deriving a set of performance goals for an application that ensure sufficient performance to deliver a target user satisfaction/conversion level. Such concepts may leverage the readily available metrics regarding latency and user satisfaction, and may employ known analysis techniques (e.g., application metrics and SEO analytics). Through correlation of these metrics, one or more performance goals may be automatically derived using real/live data (rather than guidelines and/or assumptions).

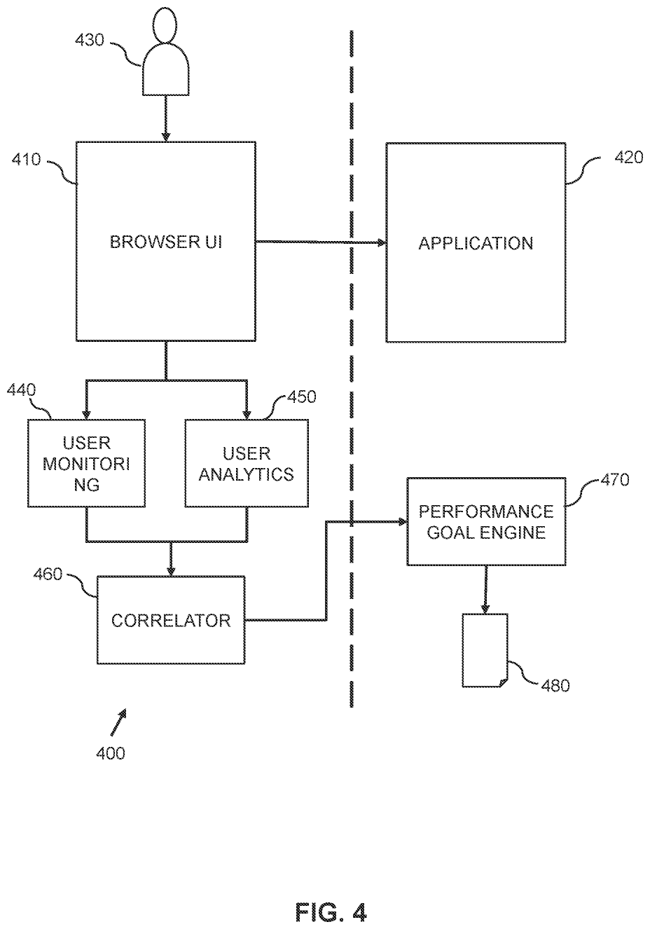

Purely by way of further description, a simplified exemplary system implementing an embodiment will now be described with reference to FIG. 4. FIG. 4 depicts a simplified block diagram of a system according to an embodiment. In this example, the target application comprises a web UI 410 (browser) and a backend system application 420. An example application is an online bookstore, where a user 430 searches for items, adds them to a cart and checks out to complete a transaction (via interactions with the web UI 410).

Step 1: Measure Latency of User Interactions with the System

A user monitoring component 440 measures the latency perceived by a user 430 interacting with the application 420 (via the UI 410). The method of measurement varies by application type; for example, the time for all elements to load for a web page, the frame load time for a single page application, or the time for a search field to update. These metrics can be measured by existing tools. Data is collected from when the user 430 first visits the site to when they eventually complete or abandon a transaction or leave.

Step 2: Measure/Derive Score of that User's Satisfaction

A user analytics component 450 is used to determine user satisfaction. The exact nature of this metric will be determined by the application. For example, in many applications, one can determine satisfaction from whether a user completes or abandons a transaction. If a user is dissatisfied with the performance of a search results page, they will never continue to purchase a product. Alternative methods could also be used, such as user surveys. Existing analytics tools can also be used to measure satisfaction.

Step 3: Aggregate Data to Produce a Histogram of Latency Vs. Satisfaction for Each User Interaction and Determine the Maximum Latency that Meets the Target Satisfaction Rate.

A correlator component 460 plots a histogram of user satisfaction vs latency, then determines a best fit line. An appropriate statistical method is then employed to choose the point at which user satisfaction has started to drop beyond an acceptable level. Such methods could include, but are not limited to:
Calculate the first derivative of the best fit line, which represents the rate of change. The target satisfaction rate may then be the point at which the rate of change is highest.
Calculate the first derivative of the best fit line, which represents the rate of change. The target satisfaction rate may then be the point at which the rate of change exceeds a certain threshold.
Calculate the point at which the satisfaction rate reduces below a certain threshold, or proportion of the maximum satisfaction rate.
Treat the line as a triphasic growth curve and identify the lag phase. The start of the lag phase may then correspond to the point at which satisfaction starts to reduce.

The abovementioned methods may be employed individually or in combination.

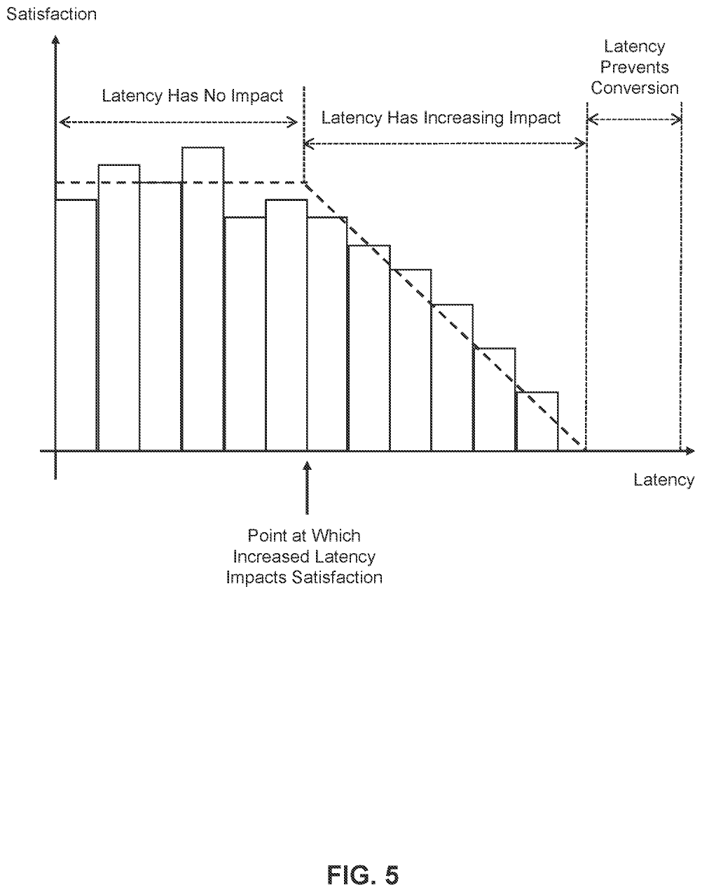

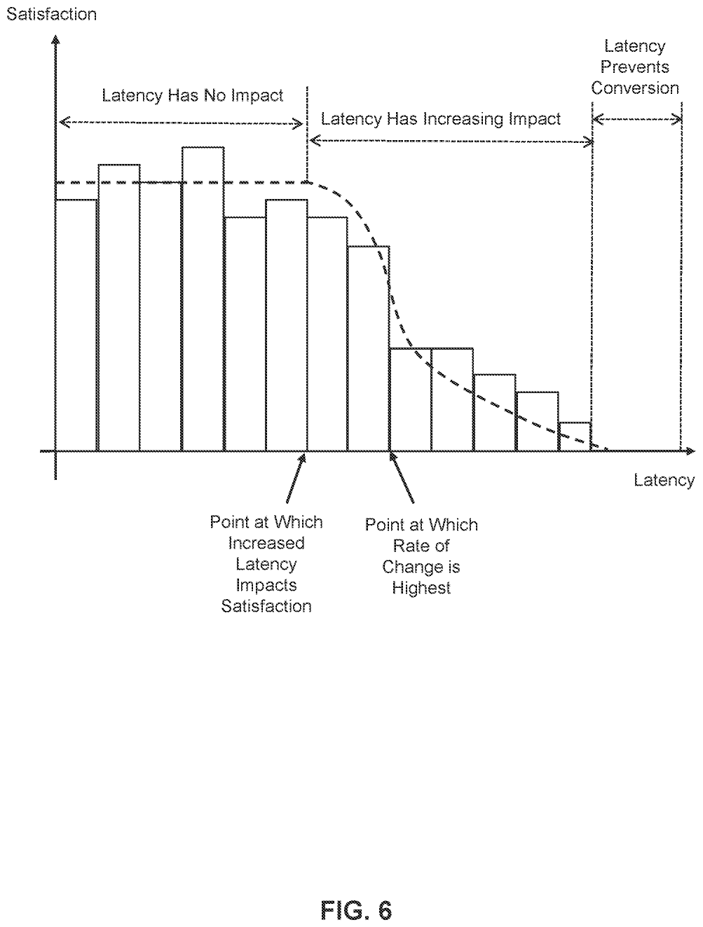

By way of example, FIGS. 5 and 6 illustrate graphs demonstrating target latency values that could be identified by one of the aforementioned methods.

FIG. 5 depicts an exemplary graph of Latency versus Satisfaction values which exhibits a linear relationship between satisfaction and latency.

FIG. 6 depicts an exemplary graph of Latency versus Satisfaction values which exhibits a non-linear relationship between satisfaction and latency.

From the graphs of FIGS. 5 and 6, it can be seen that a latency value can be identified for a target satisfaction value according to the abovementioned methods.

Step 4: Translate the Identified Latency Value into a Set of Performance Goals for the Application.

Referring back to FIG. 4, a performance goal engine 470 of the system takes the value for each histogram identified in step 1 above and outputs a performance goal 480 for the backend application that supports that interaction, which aims to keep latency within that value.

From the above description, it will be understood that there are proposed concepts for performance goal generation for a system application. These concepts may facilitate the automatic creation/definition of a performance goal in a manner which is superior to existing solutions because it allows performance goals to be aligned to real interaction and outcomes (rather than being set arbitrarily). For instance, embodiments may correlate actual user satisfaction measurements with latency measurement to determine a maximum latency value that meets a target satisfaction value. In this way, embodiments may mirror user satisfaction more realistically based on historic/recorded usage. This may ultimately improve user/customer service (e.g., better user experience, increased conversion rates, reduced cost(s), etc.).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved.

It should now be understood by those of skill in the art, in embodiments of the present invention, the proposed concepts provide numerous advantages over conventional transaction request handling approaches. These advantages include, but are not limited to, reduction of resource overhead associated with of creating specific classes of transaction.

In still further advantages to a technical problem, the systems and processes described herein provide a computer-implemented method for efficient schema generation. In this case, a computer infrastructure, such as the computer system shown in FIGS. 1 and 2 can be provided and one or more systems for performing the processes of the invention can be obtained (e.g., created, purchased, used, modified, etc.) and deployed to the computer infrastructure. To this extent, the deployment of a system can comprise one or more of:
(i) installing program code on a computing device, such as computer system shown in FIG. 2, from a computer-readable medium;
(ii) adding one or more computing devices to the computer infrastructure and more specifically the cloud environment; and
(iii) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for defining a performance goal for a system application, the method comprising:
for each of a plurality of user interactions with a system application, determining a measure of latency experienced by the user;
for at least of one of the plurality of user interactions with the system application, determining a measure of satisfaction of the user with the interaction, wherein determining a measure of satisfaction of the user comprises analyzing a user input response to a request for satisfaction information;
plotting a graph of user satisfaction versus latency based on the measure of satisfaction and the measure of latency for each of the plurality of user interactions;
fitting a line to the graph;
selecting, by a statistical method, a point on the line where user satisfaction corresponds to a minimum acceptable level;
identifying a measure of latency corresponding to a measure of satisfaction at the selected point as a target latency value;
defining a service level objective (SLO) for the system application based on the target latency value; and
continually updating the SLO to mirror user satisfaction as the system application is used.

2. The method of claim 1, wherein determining a measure of latency experienced by the user interaction comprises:
obtaining a measurement of a time taken by the application to respond to a user interaction.

3. The method of claim 2, wherein obtaining a measurement of a time taken by the application to respond to a user interaction comprises:
measuring, with a monitoring component, the time taken by the application to respond to a user interaction.

4. (canceled)

5. The method of claim 1, wherein analyzing the determined measures of latency and satisfaction comprises:
fitting a mathematical equation to the determined measures;
analyzing the mathematical equation based on a target satisfaction value to identify a latency value for the target satisfaction value; and
determining a target latency value based on the identified latency value.

6. The method of claim 1, wherein analyzing the determined measures of latency and satisfaction comprises:
generating a graph of user satisfaction versus latency based on the determined measures of latency and satisfaction;
analyzing the generated graph based on a target satisfaction value to identify a latency value for the target satisfaction value; and
determining a target latency value based on the identified latency value.

7. The method of claim 6, wherein analyzing the generated graph comprises:
determining a best fit line for the generated graph; and
employing statistical analysis to identify a latency value at which the best fit line is closest to the target satisfaction value.

8. The method of claim 1, wherein defining a performance goal comprises:
defining a requirement for maintaining latency of the system application below the target latency value.

9. The method of claim 1, wherein defining a performance goal for the system application based on the target latency value comprises:
defining, based on the target latency, a performance goal for a part of the system application that provides the plurality of user interactions.

10. The method of claim 1, wherein defining a performance goal for the system application based on the target latency value comprises:
defining, based on the target latency, a set of performance goals for the system application.

11. A non-transitory computer readable medium comprising code stored thereon that, when executed, performs a method for defining a performance goal for a system application, the method comprising:
for each of a plurality of user interactions with a system application, determining a measure of latency experienced by the user;
for at least of one of the plurality of user interactions with the system application, determining a measure of satisfaction of the user with the interaction, wherein determining a measure of satisfaction of the user comprises analyzing a user input response to a request for satisfaction information;
plotting a graph of user satisfaction versus latency based on the measure of satisfaction and the measure of latency for each of the plurality of user interactions;
fitting a line to the graph;
selecting, by a statistical method, a point on the line where user satisfaction corresponds to a minimum acceptable level;
identifying a measure of latency corresponding to a measure of satisfaction at the selected point as a target latency value;
defining a service level objective (SLO) for the system application based on the target latency value; and
continually updating the SLO to mirror user satisfaction as the system application is used.

12. A system comprising:
one or more processors; and
a memory comprising code stored thereon that, when executed, performs a method for defining a service level objective (SLO) for a system application, the method comprising:
for each of a plurality of user interactions with a system application, determining a measure of latency experienced by the user;
for at least of one of the plurality of user interactions with the system application, determining a measure of satisfaction of the user with the interaction, wherein determining a measure of satisfaction of the user comprises analyzing a user input response to a request for satisfaction information;
plotting a graph of user satisfaction versus latency based on the measure of satisfaction and the measure of latency for each of the plurality of user interactions;
fitting a line to the graph;
selecting, by a statistical method, a point on the line where user satisfaction corresponds to a minimum acceptable level;
identifying a measure of latency corresponding to a measure of satisfaction at the selected point as a target latency value;
defining a service level objective (SLO) for the system application based on the target latency value; and
continually updating the SLO to mirror user satisfaction as the system application is used.

13. The system of claim 12, wherein determining a measure of latency experienced by the user interaction comprises:
obtaining a measurement of a time taken by the application to respond to a user interaction.

14. The system of claim 13, wherein obtaining a measurement of a time taken by the application to respond to a user interaction comprises:
measuring, with a monitoring component, the time taken by the application to respond to a user interaction.

15. (canceled)

16. The system of claim 12, wherein analyzing the determined measures of latency and satisfaction comprises:
fitting a mathematical equation to the determined measures;
analyzing the mathematical equation based on a target satisfaction value to identify a latency value for the target satisfaction value; and
determining a target latency value based on the identified latency value.

17. The system of claim 16, wherein analyzing the determined measures of latency and satisfaction comprises:
generating a graph of user satisfaction versus latency based on the determined measures of latency and satisfaction;
analyzing the generated graph based on a target satisfaction value to identify a latency value for the target satisfaction value; and
determining a target latency value based on the identified latency value.

18. The system of claim 17, wherein analyzing the generated graph comprises:
determining a best fit line for the generated graph; and
employing statistical analysis to identify a latency value at which the best fit line is closest to the target satisfaction value.

19. The system of claim 12, wherein defining a performance goal comprises:
defining a requirement for maintaining latency of the system application below the target latency value.

20. The system of claim 12, wherein defining a performance goal for the system application based on the target latency value comprises:
defining, based on the target latency, a performance goal for a part of the system application that provides the plurality of user interactions.
